(19) United States
(12) Patent Application Publication
(10) Pub. No.: US 2010/0181374 A1
(43) Pub. Date: Jul. 22, 2010

(54) DEVICE FOR TRANSFERRING MEDICAL PRESCRIPTIONS

(76) Inventors: Dinesh J. Martis, Loveland, OH (US); Sunil G. Kulkarni, Cincinnati, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/642,471

(22) Filed: Dec. 18, 2009

Related U.S. Application Data
(60) Provisional application No. 61/138,818, filed on Dec. 18, 2008.

(51) Int. Cl. G06F 19/00; H04Q 5/22; G06F 3/033

(52) U.S. Cl. 235/375; 340/10.1; 345/179

(57) ABSTRACT

A device for transferring medical prescription information from a prescriber to a medical service provider. The device includes a support structure configured to support a storage tag and a storage tag inextricably attached to the support structure. The storage tag includes an electronic circuit configured to receive, store and transmit prescriber generated prescription information.

### RELATED APPLICATIONS

This application claims priority under 35 U.S.C. §119(e) to U.S. Provisional Application Ser. No. 61/138,818, filed Dec. 18, 2008.

### FIELD OF THE INVENTION

The invention relates generally to medical prescriptions and will be specifically disclosed in connection with a medical prescription device that includes a storage tag for storing information relating to a medical prescription. In one preferred embodiment, electronic data associated with the prescription or an electronic copy of the prescription itself is stored on a RFID (Radio Frequency Identification) tag embedded in a paper prescription form.

### BACKGROUND OF THE INVENTION

Conventional medical prescriptions are known in the art. In particular, a typical medical prescription utilizes a paper media and requires the medical provider to hand write or type the prescription on the paper. The paper also commonly includes additional information, such as, the medical provider's name, address, telephone number and title. Once completed, the person receiving the prescription typically takes it to their pharmacist or other medical service provider and thereby receives the prescribed medication, medical service or medical product.

Unfortunately, due to the addictive properties of some prescription drugs and the general needs and desires of some individuals, prescription fraud (i.e., forgery or, generally, some other manipulation of the prescription itself) has grown at an alarming rate over recent years and produces substantial economic losses for the payor sources, such as insurance companies, Medicare and Medicaid. In addition, prescription drug use by individuals in a manner not prescribed by a physician also poses further medical and legal complications. For example, such use of prescription drugs promotes a person's addictions and increases and/or amplifies the person's risk for other health-related ailments. As such, unprescribed use adds additional costs to an already overburdened health care system.

In response to the mounting losses resulting from prescription fraud and misuse of prescription drugs, recent federal and state laws have required prescription paper suppliers to incorporate recent technological advancements into the prescription paper itself. These guidelines may include: (a) one or more features designed to prevent unauthorized copying of a completed or blank prescription form; (b) one or more features designed to prevent the erasure or modification of information written on the prescription by the prescriber; and/or (c) one or more features designed to prevent the use of counterfeit prescription forms. For example, recent technology has enabled the prescription paper to be created utilizing security features, such as, unique batch and sequential numbers assigned to each prescriber, watermarks, microprinting and thermochromic ink, which changes colors or disappears temporarily with hot air or when rubbed briskly. However, even by employing all the currently known security features, prescriptions are still susceptible to fraud and misuse through reproductions, forgery and other manipulations. In addition, these recent methods of fraud prevention are only aimed at preventing manipulation to the prescription paper itself as opposed to also validating whether an authorized prescriber has created the prescription for the authorized person receiving the medication from the pharmacist or other medical services/goods from the medical service provider.

Even with the magnitude of economic losses from fraudulent transactions and misuse, there is substantial pressure to insure that prescriptions are written by authorized prescribers and are delivered only to the prescribed or a person authorized by the prescribed, even in the face of possible fraud. As such, there remains a need for a prescription paper which overcomes the susceptibility to fraud and misuse noted above and ensures that the prescription is delivered by the authorized individual to the proper person.

### SUMMARY OF THE INVENTION

In one embodiment of the invention, a device for transferring medical prescription information from a prescriber to a medical service provider includes a support structure configured to support a storage tag and a storage tag inextricably attached to the support structure. The storage tag can include an electronic circuit configured to receive, store and transmit prescriber generated prescription information.

In another aspect of one embodiment of the invention, the storage tag is positioned between a front face of the support structure and a back face of the support structure.

In one embodiment of the invention, the electronic copy is a photograph of the written prescription information.

According to an aspect of one embodiment, the electronic copy is an exact copy of the written prescription information.

In yet another embodiment of the invention, a digital or electronic pen is used to create the written prescription information.

In one embodiment of the invention, the storage tag is configured to transmit the electronic prescription information when activated by a reader.

According to an aspect of one embodiment, the storage tag is configured to transmit in the radio frequency spectrum.

In one embodiment of the invention, the storage tag is configured to capture data that includes biometric information.

In yet another embodiment of the invention, the support structure and the storage tag can include unique batch and sequential numbers.

In another embodiment, a prescription transfer device, comprises a physical media for transferring prescription information from a prescriber to a medical service provider and an electronic storage tag inextricably associated with and carried by the physical media. The electronic storage tag includes electronic storage configured to receive and store prescriber generated prescription information electromagnetically transferred by a prescriber while the electronic tag is inextricably associated with the physical media and electromagnetically transmit the prescription information stored on the storage tag to a reader operated by the medical service provider.

In yet another embodiment, a method of transferring medical prescription information, comprising the steps of writing prescriber generated medical prescription information on a prescription form, electronically capturing the prescriber generated medical prescription information written and the form, and transferring the captured information to an electronic storage device while the electronic storage device is inextricably attached to the prescription form.

### BRIEF DESCRIPTION OF THE DRAWINGS

While the invention concludes with claims which particularly point out and distinctly claim the invention, it is believed the present invention will be better understood from the following description taken in conjunction with the accompanying drawings, in which like reference numbers identify the same elements in which:

FIG. 1 is a plan view of a medical prescription employing a tag and additional security features constructed in accordance with the principles of the present invention;

FIG. 2 is a schematic view of a “passive” tag, including an integrated circuit and antenna constructed in accordance with the principles of the present invention;

FIG. 3 is a schematic view of an “active” tag, including an integrated circuit, antenna and power source constructed in accordance with the principles of the present invention and

FIG. 4 is a plan view of a medical prescription employing a storage tag constructed in accordance with the principles of the present invention.

Reference will now be made in detail to certain exemplary embodiments of the invention, examples of which are illustrated in the accompanying drawings.

### DETAILED DESCRIPTION

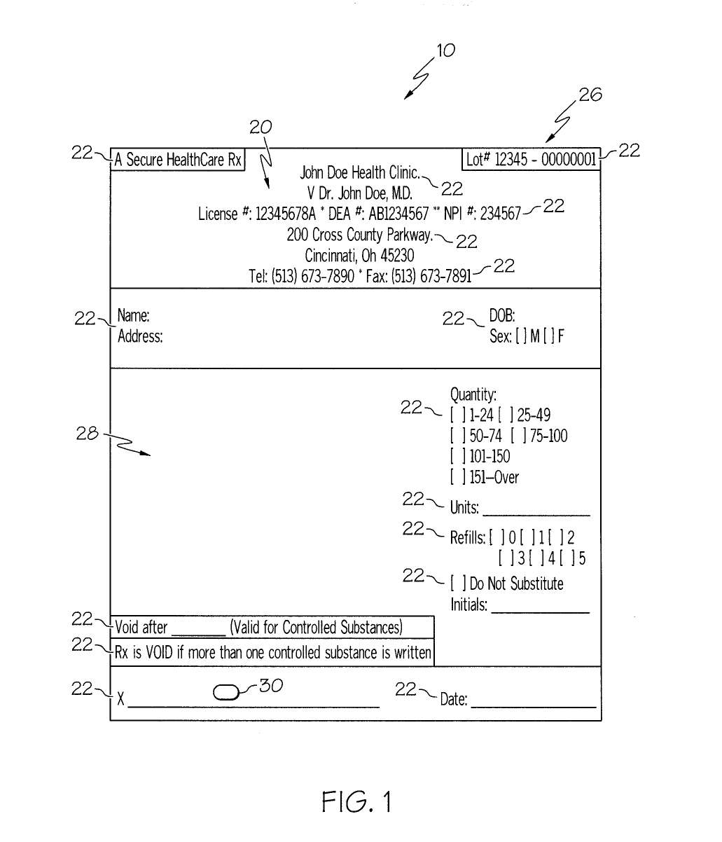

Referring now to the drawings, FIG. 1 shows a plan view of one embodiment of a medical prescription form, generally designated in the drawings by the numeral 10, constructed in accordance with the principles of the present invention. The illustrated medical prescription form 10 includes a support structure 20 and a storage tag 30, as described in greater detail below. The support structure 20 is commonly made of paper or some other material and can include written prescription information 22, such as the pre-printed information of, the medical provider's name, address, telephone number and title, the patient's name, address and sex and dosage information. However, it will be understood that the support structure 20 may be constructed of any material and may include any written prescription information, as known in the art. In one specific embodiment, the support structure may be constructed of plastic or some other resilient material or materials. It will be understood that a support structure made of such a resilient material or materials are advantageous because they may be reused, as known in the art. It will also be understood that the support structure 20 may be provided with a space 28 for the physician to write or type patient specific prescription information, such as drug and dosage amounts. Furthermore, it will be also understood that any additional conventional security features may be used in association with the support structure 20, as known in the art. For example, additional conventional security features 26 may include, unique batch and sequential numbers assigned to each prescriber, watermarks, microprinting, thermochromic ink, which changes colors or disappears temporarily with hot air or when rubbed briskly, and any other security feature instituted by any entity, person or law. In one embodiment of the present invention, the support structure 20 may be constructed of a material configured to be scanned, copied or faxed. It will be understood that the ability of the support structure 20 to be scanned, copied or faxed will enable the prescriber to email, fax or otherwise transmit through wireless or through any other known transmission methodology the prescription electronically to the pharmacist or any other potential recipient. FIG. 1 further illustrates a storage tag 30 embedded within the structure of the support member 20.

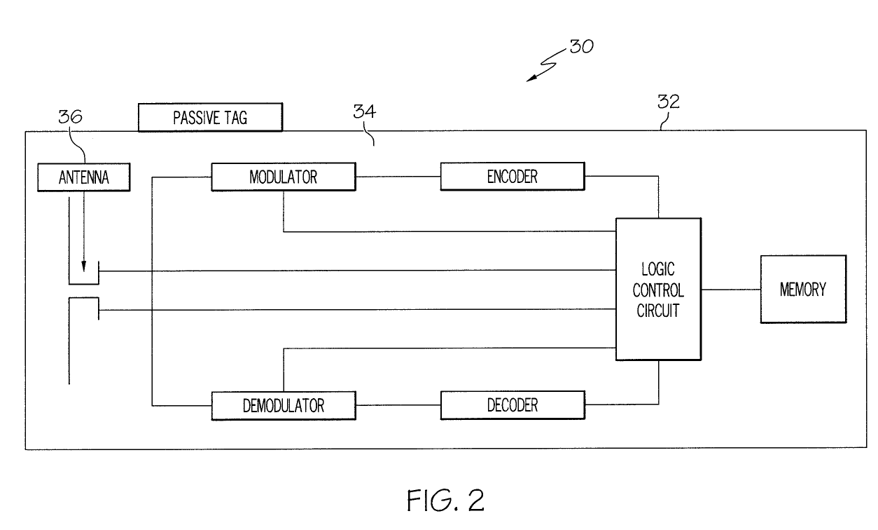

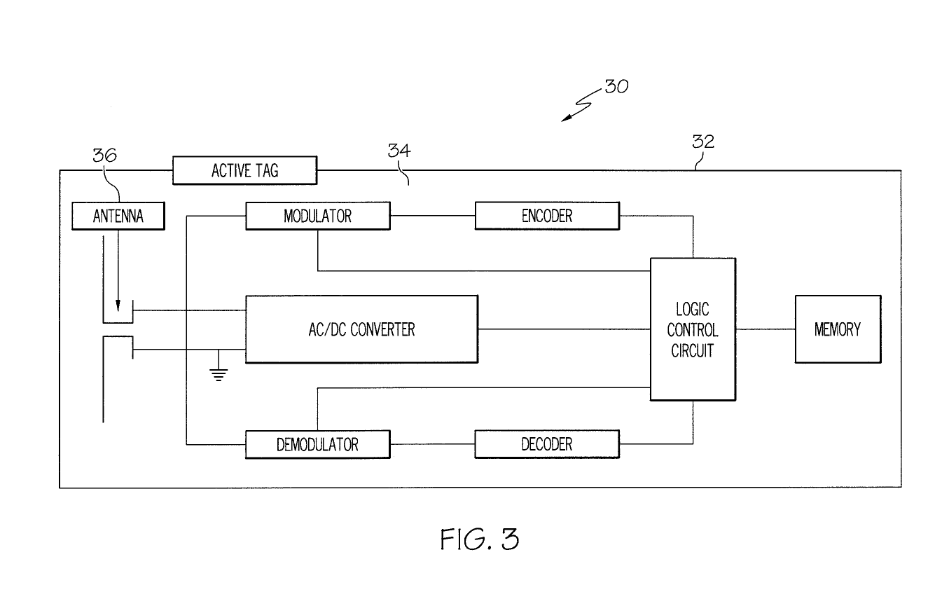

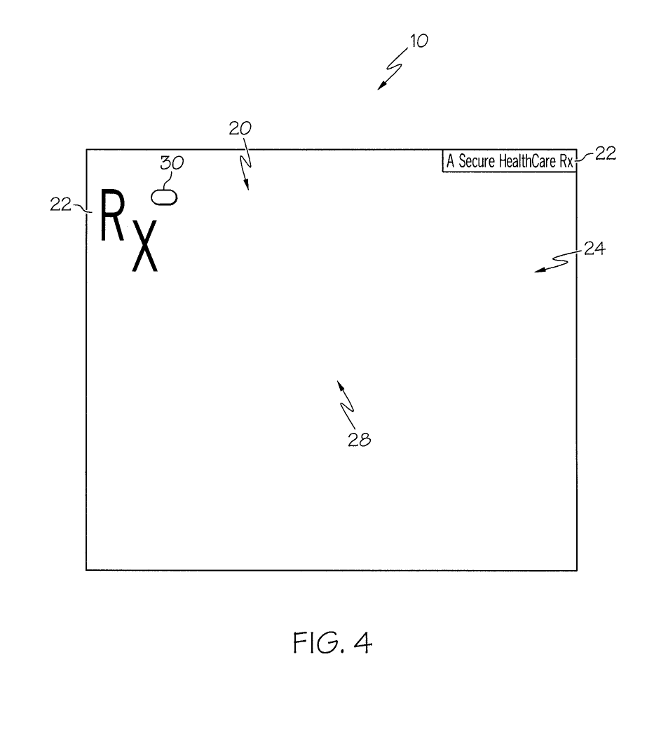

With reference to the exemplary embodiment illustrated in FIGS. 2 and 3, the illustrated storage tag 30 includes a housing 32 which secures and at least partially encloses an integrated circuit 34 and an antenna 36. It will be understood, however, that in some embodiments storage tag 30 may include a magnetic strip, bar code, two-dimension bar code or any other media which can receive, store and transmit date without departing from the scope of the present invention. It will be also understood that the housing 32 may be composed of any number of suitable materials, as well known in the art. The particular material selected may depend upon the intended use. For many specific application involving medical prescription information, the storage tag 30 may be designed to be single use, but in other applications, it may be desirable to reuse the storage tag 30. In the illustrated exemplary embodiment of FIGS. 2 and 3, an integrated circuit 34 is used, as is well known in the art. A storage tag 30 which may be configured to receive, store and transmit in the radio frequency (RF) spectrum is illustrated in the exemplary embodiments of FIGS. 1-4 and will be used throughout the present disclosure. However, it will be understood that the storage tag 30 may be configured to receive, store and transmit in any spectrum, as known in the art, could be used without departing from the scope of the present invention. In one specific embodiment, the storage tag 30 may only be written to or read by a specific RFID writer.

It will be further understood that a storage tag 30, in accordance with the present invention, may be configured to be either an active, a passive tag or a semi-passive tag. In particular, as known in the art, an “active tag” (as illustrated in FIG. 3) is a storage tag which supplies its own energy from an energy source 38, such as a battery, a “passive tag” (as illustrated in FIG. 2) is a storage tag which does not have its own power supply and which is activated only by a tag reader, and a “semi-passive tag” (not illustrated) is a storage tag which supplies its own energy from an energy source to power the broadcasting of the signal but does not power the integrated circuit. It will be understood that passive tags allow for heightened security as they can be configured to be read only at a specific and predetermined frequency. In one particular embodiment of the present invention, the storage tag 30 may be configured to only be read by a reader for a predetermined amount of time before it can not be read any longer. For example, in this particular embodiment the storage tag 30 may be configured to be read only for 72, 48 or 24 hours. In another embodiment of the present invention, the storage tag 30 may be configured to only be read by certain pre-identified readers. Once the storage tag 30 is read it will be understood that the stored data may be extracted from the tag 30 and communicated in any manner, as known in the art. For example, in one embodiment the data stored on the storage tag 30 may be printed, faxed, emailed, transmitted through wireless, Bluetooth, phone lines or any other known transmission medium or saved onto an electronic storage media, such as a computer, server or web based storage. In one specific embodiment, the data stored on the storage tag 30 can be sent to various and disparate databases and electronic medical solutions and be read and understood by these various databases and/or electronic medical solutions.

In the exemplary embodiments illustrated in FIGS. 1 and 3, only a single storage tag 30 is positioned on a front surface 24 of the support structure 20. It will be understood, however, that any amount storage tags 30 may be used in accordance with the present invention. It will further be understood that the storage tag 30 may be secured to a front surface 24 by any means known in the art. For example, the storage tag 30 may be secured by gluing, stitching, laminating or welding. Whatever, the method of securing the storage tag 30 to the support structure 20, for many medical prescription applications, it may be highly advantageous to inextricably secure the storage tag 30 to the support structure 20 so that removal of the storage tag 30 from the support structure 20 results in destruction of either or both of the support structure 20 or storage tag 30. Furthermore, it will also be understood that in still further embodiments that the storage tag 30 may be positioned on any portion of the support structure 20. For example, the storage tag 30 may be positioned on back surface (not shown) or at least partially between the front surface 24 and the back surface. In one specific embodiment, the storage tag 30 may be positioned entirely between the front surface 24 and the back surface. In one embodiment, a tamper-resistant tag 30 is attached to the support structure 20. It will be understood that in this particular embodiment the support tag 30 may self-destruct or otherwise render the tag 30 permanently inoperable if the tag 30 is removed from the support structure 30 or otherwise manipulated with.

The storage tag 30 is configured to capture data. It will be understood that any type of data may be captured by the tag 30, and may also include any encryption key or security feature, such as random numbers or unique batch and sequential numbers assigned to each prescriber, as known in the art. In one exemplary embodiment, the storage tag 30 may be configured to capture electronic prescription information. For example, the electronic prescription information may include the medical provider's name, address, telephone number and title, the patient's name, address and sex, dosage type and amounts, medical notes or any other type of information. It will be understood that such electronic prescription information may be written to the tag 30 at the time of examination, prior to the examination, or at any other time as known in the art. In yet another embodiment, the storage tag 30 may be configured to capture information positioned on the front face 24 of the support structure 20. In one specific embodiment, the storage tag 30 may be configured to capture and exact copy of the information positioned on the front face 24 of the support structure 20. In one embodiment, a camera may be used, as known in the art. In yet another embodiment, the storage tag 30 may be configured to capture the prescription information written by the prescriber on the front face 24 of the support structure 20. In this specific embodiment, a digital or electronic pen may be used, as known in the art. The digital or electronic pen, in this specific embodiment, may be configured such that the pen can not be used to write to any other tag 30 and/or the tag 30 can not be written to by any other pen. It will be understood that such a relationship can be referred to as a “one-to-one” relationship. In yet another specific embodiment, the storage tag 30 may be configured to receive, store and transmit data created through a person's voice and recognized through the use of voice-recognition software. In this specific embodiment, the storage tag 30 may be configured such only a pre-identified voice or pre-identified voices can write to the tag 30. In yet another embodiment, the electronic tag 30 may include electronic storage configured to receive and store prescriber generated prescription information electromagnetically transferred by a prescriber while the electronic tag 30 is inextricably associated with the physical media and electromagnetically transmit the prescription information stored on the tag to a reader operated by the medical service provider.

In yet another embodiment, the tag 30 may be configured to capture biometric information. In this specific embodiment, biometric information may include, for example, fingerprint data, oxygen saturation levels, pulse data, retinal data, vein pattern data, or any other type of biometric information. The biometric information may be captured from the prescriber, patient, both or anyone else involved in the transaction. It will be understood that by analyzing the biometric information captured on the tag 30, a pharmacist or other person reviewing the data on the tag 30 may validate whether an authorized prescriber has created the prescription, whether an authorized person has received the prescription (i.e. the intent of the prescriber to deliver the prescription to a particular person) and/or further validate the person to whom the medication, medical service or medical product has been delivered.

Advantageously, the medical prescriptions illustrated in the exemplary embodiments of FIGS. 1-3 allow for, inter alia, secure prescription writing. That is, prescriptions written in accord with the principles described herein help eliminate the occurrence of fraud and misuse and help ensure that the prescription is delivered to the proper individual.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. A device for transferring medical prescription information from a prescriber to a medical service provider, comprising:
a support structure configured to support a storage tag; and
a storage tag inextricably attached to the support structure, wherein the storage tag includes an electronic circuit configured to receive, store and transmit prescriber generated prescription information.

2. A device as recited in claim 1, wherein the storage tag is positioned between a front face of the support structure and a back face of the support structure.

3. A device as recited in claim 1, wherein the electronic copy is a photograph of the written prescription information.

4. A device as recited in claim 1, wherein the electronic copy is an exact copy of the written prescription information.

5. A device as recited in claim 1, wherein a digital pen creates the electronic copy.

6. A device as recited in claim 1, wherein storage tag is configured to transmit the electronic prescription information when activated by a reader.

7. A device as recited in claim 1, wherein the storage tag is configured to transmit in the radio frequency spectrum.

8. A device as recited in claim 1, wherein the storage tag is configured to capture data that includes biometric information.

9. A device as recited in claim 1, wherein the support structure includes unique batch and sequential numbers.

10. A device as recited in claim 1, wherein the storage tag at least partially relays written prescription information.

11. A device as recited in claim 11, wherein the written prescription information is pre-printed data, prescriber generated data or both.

12. A device as recited in claim 1, wherein the storage tag includes an electronic copy of the written prescription information.

13. A prescription transfer device, comprising:
a physical media for transferring prescription information from a prescriber to a medical service provider; and
an electronic tag inextricably associated with and carried by the physical media, the electronic tag including electronic storage configured to
(i) receive and store prescriber generated prescription information electromagnetically transferred by a prescriber while the electronic tag is inextricably associated with the physical media; and
(ii) electromagnetically transmit the prescription information stored on the tag to a reader operated by the medical service provider.

14. A method of transferring medical prescription information, comprising the steps of:
(a) writing prescriber generated medical prescription information on a prescription form;
(b) electronically capturing the prescriber generated medical prescription information written and the form; and
(c) transferring the captured information to an electronic storage device while the electronic storage device is inextricably attached to the prescription form.

15. A method of transferring medical prescription information as recited in claim 14, wherein the captured information is transferred to the storage device wirelessly.

16. A method of transferring medical prescription information as recited in claim 14, wherein the prescriber generated information is captured by capturing an image of the prescription form after the prescriber generated information is written to the form.

17. A method of transferring medical prescription information as recited in claim 14, wherein the prescriber generated information is captured simultaneously with the step of writing the information.

18. A method of transferring medical prescription information as recited in claim 14, wherein the prescriber generated information is captured by the same instrument used to write the prescriber generated information.

19. A method of transferring medical prescription information as recited in claim 14, wherein the captured information is transferred to the storage device electromagnetically.
